(19) United States
(12) Patent Application Publication
(10) Pub. No.: US 2010/0050619 A1
(43) Pub. Date: Mar. 4, 2010

(54) Nanotechnology Based Heat Generation and Usage

(75) Inventors: John C. Colvin, The Woodlands, TX (US); Daniel Bullock, The Woodlands, TX (US); Kanti Penmetsa, The Woodlands, TX (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: HOUSTON ADVANCED RESEARCH CENTER, The Woodlands, TX (US)

(21) Appl. No.: 12/553,781

(22) Filed: Sep. 3, 2009

Related U.S. Application Data
(60) Provisional application No. 61/093,776, filed on Sep. 3, 2008.
(60) Provisional application No. 61/106,694, filed on Oct. 20, 2008.

(51) Int. Cl. F01N 3/023; H05B 6/64; F24H 3/00

(52) U.S. Cl. 60/311; 219/759; 422/174; 392/355

(57) ABSTRACT

Carbon nanotube material dispersed in a dense material such as ceramic can produce heating when exposed to microwave radiation (e.g., electromagnetic radiation in the frequency range of approximately 0.3 GHz to 300 GHz). By changing the loading of carbon nanotube material within a ceramic medium, one can affect the heating capability of the medium in dramatic and unpredicted fashion. This finding can be used to implement heating devices that heat via conduction or through radiation (e.g., infrared heating).

### BACKGROUND

This application claims priority to U.S. provisional patent applications: 61/093,776 entitled “Microwave Heating Using Carbon Nanotechnology” (filed 3 Sep. 2008) and 61/106,694 entitled “A Novel Infrared (IR) Heater to Reduce Energy Consumption While Maintaining Thermal Quality for Personnel Working in a Commercial Building Environment” (filed 20 Oct. 2008). This application is also related to patent application Ser. No. 12/421,225 entitled “Nanotechnology Bases Image Reproduction Device” (filed 9 Apr. 2009) previously provisional patent application 61/043,629 entitled “Heating of Copy Machine Fusing Roller by Carbon Nanotube Absorption of Microwave Radiation” (filed 9 Apr. 2008). Each of these applications are hereby incorporated by reference.

Heating is required for a large number of processes used in industrial, commercial, and residential settings. A large number of heat producing devices have been developed to supply thermal energy for these processes, the bulk of which use conventional resistance (Ohmic) or inductive circuits, or liquid or gaseous fuels to generate the required thermal energy. An alternative approach involves the use of electromagnetic radiation, and specifically microwave radiation, although the approach has been limited to primarily the heating of mediums with high water content. While a few devices have been developed to use microwaves to heat media other than water (rubber vulcanization for example), widespread implementation of microwave heating has been limited due to the prevalence of low absorption efficiency of microwave energy by a wide range of materials including many polymers, glasses and ceramics.

Carbon nanotubes and related molecules are known to exhibit a high absorption coefficient for a wide range of electromagnetic radiation wavelengths including the visible spectrum, microwave, and radio frequencies. Some research has been undertaken to produce composite materials comprised of carbon nanotubes and various other materials for the purpose of modifying the absorption coefficient with regard to a particular part of the electromagnetic spectrum, but prior research has not focused on the addition of carbon nanotubes for the specific purpose of heating. With respect to dense materials such as ceramics, studies by Ye teach that microwave radiation would not vibrate embedded carbon nanotubes and would not, therefore, be expected to heat such materials. Ye explains, “To increase the density is equivalent to an increase of the damping of carbon nanotubes. This can be explained by the fact that transverse vibration of a carbon nanotube requires the space around the tube to be large enough to make a free vibration. If there is not enough space, transverse vibration would be impossible.” Z. Ye, W. D. Deering, A. Krokhin, and J. A. Roberts: Microwave absorption by an array of carbon nanotubes: a phenomenological model. Phys Rev B, 74, 075425/1 (2006).

### BRIEF DESCRIPTION OF THE DRAWINGS

FIG. 1 shows temperature versus time data for silicon carbide samples with carbon nanotube loading of between 0.0 and 1.0 wt-% at 200 watts of applied microwave radiation.

FIG. 2 shows temperature verses time data for cordierite samples with carbon nanotube loading of between 0.0 and 1.0 wt-% at 200 watts of applied microwave radiation.

FIG. 3 shows temperature verses time data for cordierite samples with carbon nanotube loading of between 0.0 and 1.0 wt-% at 500 watts of applied microwave radiation.

FIG. 4 shows, is cross-section, a schematic view of a diesel particulate filter application in accordance with one embodiment of the invention.

FIG. 5 shows, in flowchart form, a method of using a diesel particulate filter in accordance with one embodiment of the invention.

FIG. 6 shows, in schematic form, a heating and cooling system in accordance with one embodiment of the invention.

FIG. 7 shows, in block diagram form, a heating unit in accordance with one embodiment of the invention.

FIGS. 8A-8D show illustrative heating element substrate layouts in accordance with the invention.

### DETAILED DESCRIPTION

In contradiction to the teaching of Ye (discussed above), the inventors have shown that carbon nanotube material dispersed in a dense material, such as ceramic, produce heating when exposed to microwave irradiation (i.e., electromagnetic radiation in the frequency range of approximately 0.3 GHz to 300 GHz). Thus, the invention is directed generally to materials, methods, devices and systems for generating heat by increasing the absorption of microwave energy in ceramic materials through the incorporation of carbon nanotube material therein. More specifically, the inventors have found that changing the loading of carbon nanotube material within a ceramic medium affects the heating capability of the medium in dramatic and unpredicted fashion.

Practical applications of this finding include, but are not limited to, a broad array of heated devices or processes that currently use resistance (Ohmic) or induction circuits, or liquid fuels to generate heat. Illustrative heated devices include, but are not limited to, domestic appliances such as stovetops, space heaters, water heaters and industrial process such as heated presses, rollers, laminators, and related equipment. In particular, the inventive principle is well suited for applications where the heat transfer media requires a fast temperature rise or drop. As used here, the term “loading” refers to the weight percentage of carbon nanotube material relative to the base medium or substrate. While one of ordinary skill in the art will recognize a wide range of ceramic base materials may be applicable, the illustrative embodiments described herein use silicon carbide and cordierite.

Carbon Nanotube Material. The type of carbon nanotube material used to create data upon which the following illustrative embodiments are based was non functionalized multi-walled carbon nanotubes. Carbon nanotubes can, however, include multi-walled, functionalized multi-walled, raw single walled and purified single walled nanotubes, buckytubes, C-60 buckyballs, fullerene tubes, carbon fibrils, carbon nanotubules, stacked cones, horns, carbon nanofibers, vapor-grown carbon fibers, and combinations thereof. They may comprise a variety of lengths, diameters, chiralities (helicities), number of walls, and they may be either open or capped at either or both ends. Furthermore, they may be chemically functionalized in a variety of manners. Carbon nanotubes used in accordance with the invention may be made by any known technique (e.g., arc method, laser oven, chemical vapor deposition, flames, HiPco, etc.) and may be in a variety of forms, e.g., soot, powder, fibers, “bucky papers,” etc. From the perspective of commercialization, the type of carbon nanotechnology used is relevant only because there is currently a significant difference in cost between the various types of carbon nanotechnologies.

Ceramic Samples: the type of ceramic materials used in the following illustrative examples include silicon carbide and cordierite. In order for the silicon carbide and cordierite samples to have a uniform dispersion of carbon nanotubes, the nanotubes were carefully weighed to establish their weight percentage. To establish the optimum carbon nanotube density within the target ceramic material, samples were made with 0.25, 0.50, 0.75 and 1.00 weight percentages. (The phrase “X weight-percentage” means that if the total weight of the ceramic sample material—including nanotube material—is Y, X % of that is attributable to carbon nanotube material.)

The nanotubes were dispersed in tetrahydrofuran (CAS 109-99-9) and ultrasonicated until the stratified solution formed a colloidal suspension. The suspension was homogenized by stirring under heat while the ceramic material was slowly added to the suspension. Most of the tetrahydrofuran evaporated during this process. The mixture was placed in an 80° C. oven for 12 hours, which evaporated the remaining tetrahydrofuran. The mixture was transformed into a fine powder using a mortar and pestle. The fine ceramic powder was poured into a dye and pressed into 25 mm diameter discs. The ceramic discs were sintered at a temperature of 1,400° C. in an oven, which slowly ramped up to the sintering temperature. Once the sintering temperature was reached, the oven was programmed to turn off for cool down to room temperature.

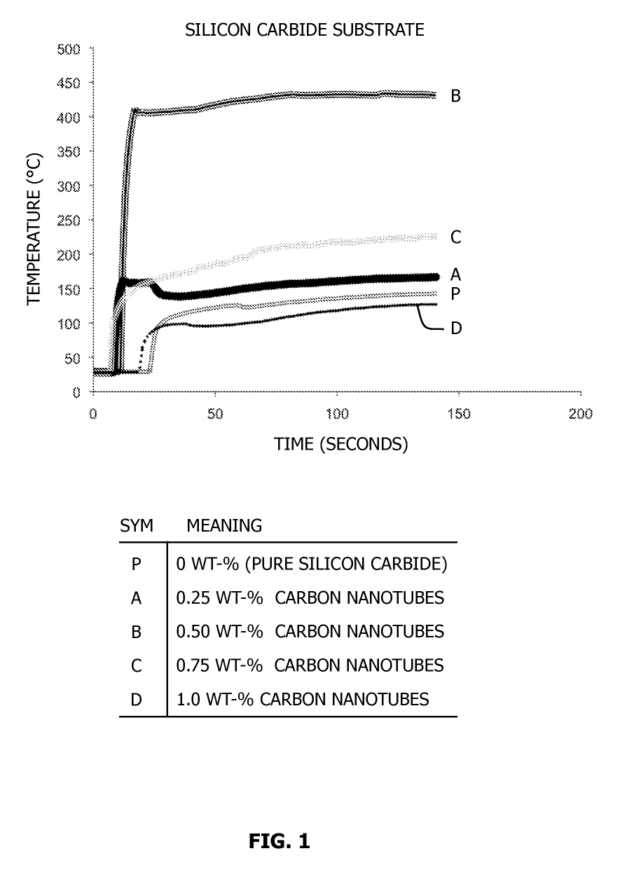

Test Data: FIG. 1 shows temperature versus time data for silicon carbide samples fabricated as described above with carbon nanotube loading of between 0.0 and 1.0 wt-% at 200 watts of applied microwave radiation (2.45 GHz). The data show that the maximum temperature achieved in the sample with no carbon nanotubes (curve “P”) was about 130° C., while the silicon carbide sample with 0.50 wt-% carbon nanotubes (curve “B”) reached a temperature of approximately 400° C. in about 10 seconds.

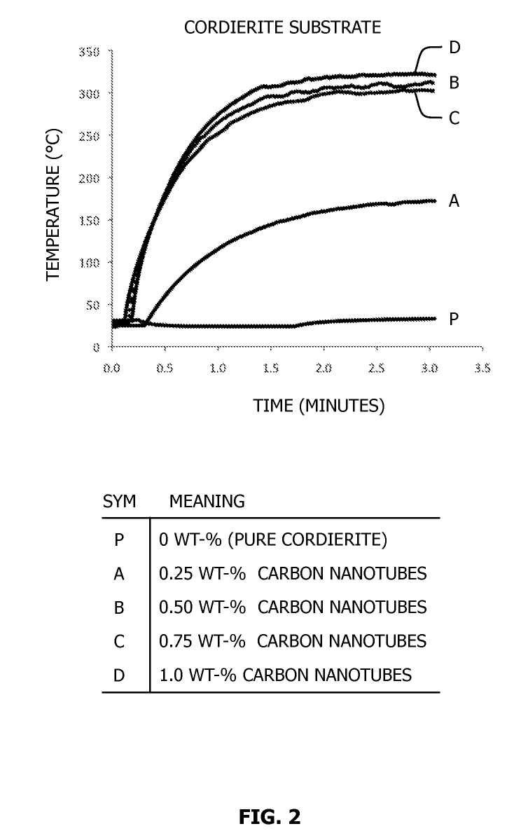

FIG. 2 shows temperature verses time data for cordierite samples fabricated as described above with carbon nanotube loading of between 0.0 and 1.0 wt-% at 200 watts of applied microwave radiation (2.45 GHz). As shown, the cordierite samples with carbon nanotube loadings of 0.5, 0.75 and 1.0 wt-% all reached a temperature above 300° C. within approximately 60 seconds, while the temperature of the cordierite sample without carbon nanotubes did not change.

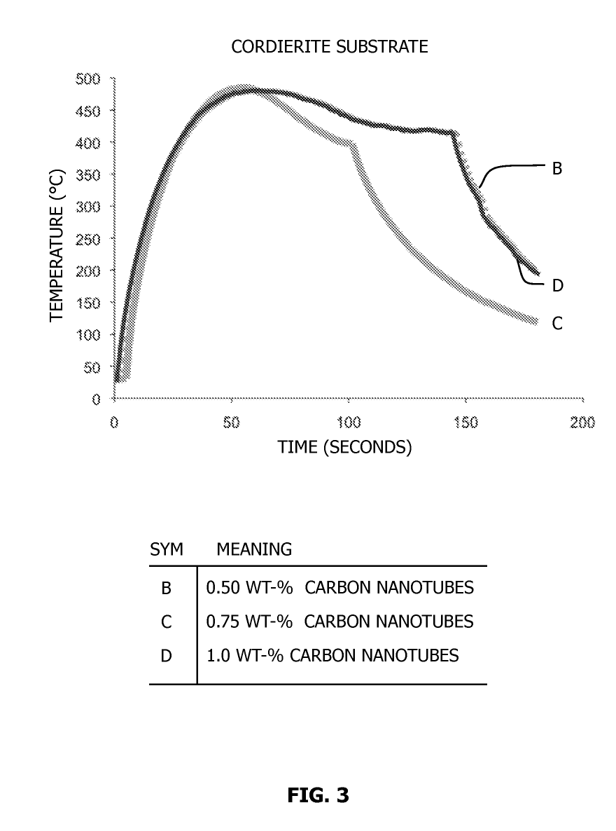

FIG. 3 shows temperature verses time data for cordierite samples fabricated as described above with carbon nanotube loading of between 0.0 and 1.0 wt-% at 500 watts of applied microwave radiation (2.45 GHz). As shown, the temperature of all three cordierite samples increased from room temperature to above 450° C. in less than 50 seconds.

Discussion: FIGS. 1-3 illustrate clearly, and in contrast to prior art teachings, that ceramic material having embedded carbon nanotube material may be heated using microwave radiation. This finding may be applied using two general approaches. In the first, microwave radiation may be used to heat material that is in direct contact with a substrate containing carbon nanotubes. Here, conduction causes the microwave energy absorbed by the carbon nanotubes to be transferred to the material—where the material may be solid (e.g., soot or other particulate matter), liquid (e.g., water or oil) or gaseous (e.g., air). In the second, microwave radiation may be used to heat an object distal from a substrate containing carbon nanotubes. In embodiments of this type, microwave energy absorbed by the carbon nanotubes may be transferred to the distal object via radiation (e.g., infrared radiation). Illustrative heated devices include, but are not limited to, domestic appliances such as stovetops, space heaters, water heaters and industrial process such as heated presses, rollers, laminators, and related equipment. Specific illustrative examples of these approaches are described below. In particular, a diesel particulate filter is described as an example of the “direct contact” approach while a space heater system is described as an example of the “radiative” heating approach.

A first illustrative application in accordance with the invention involves the filtering of particulate matter from diesel engine exhaust. In an effort to reduce diesel emissions, including oxides of nitrogen and particulate matter (commonly known as soot), the U.S. Environmental Protection Agency is promoting the adoption of new after-treatment technologies in vehicle exhaust streams. A number of approaches to treat exhaust streams have been devised, including diesel particulate filters fabricated from silicon carbide or cordierite. Some of these approaches have investigated the use of microwave irradiation of silicon carbide filters to initiate regeneration, although these studies have resulted in devices where the microwave system's energy requirements exceed the capabilities of vehicle electrical systems. As a result, no commercially practical microwave regenerated particulate filter technology has been developed. In addition, although particulate filters fabricated with cordierite have a number of useful advantages compared to silicon carbide, microwave regeneration has not been possible due to the cordierite's transparency to microwave energy. The invention described herein addresses both of these issues and results in commercially viable microwave regenerated filters.

Diesel particulate filters (DPF) are used in the exhaust systems of diesel engines to trap and combust carbon based particulate matter. As the engine exhaust flows through the DPF, particulate matter or soot is trapped and over time accumulates in the filter. The accumulation of soot increases the resistance to the flow of exhaust gas thus creating a back pressure typically in the range of 5 to 10 kPa on the engine. The filter is a ceramic material formed into many parallel channels running in the filter's axial direction and separated by thin porous walls. One half of the channels are open only on the inlet side of the filter thus forcing the gas flow through the porous walls and out the open channels on the exit side. The soot is too large to pass through the wall and is thus trapped on the inner surface of the channel. The soot is removed from the filter by a process known as regeneration.

Regeneration occurs when the soot combusts in the filter at temperatures between approximately 450° C. and 600° C. The exact combustion temperature depends on the method of regeneration. If the system employs a catalyst, the regeneration temperature of the soot is typically reduced to between 325° C. and 400° C. The catalyst's primary function is to lower the soot combustion temperature, thus permitting lower regeneration temperatures. The catalyst system, known as a passive regenerated DPF, requires a hot duty cycle for a high percentage of the engine operating time in order to maintain a continuous regeneration. Without the hot duty cycle, the filter will become clogged with soot, which not only increases back pressure on the engine, but could lead to an uncontrolled regeneration that can raise the temperature in the DPF high enough to damage the ceramic material.

Although a passive DPF system is currently the preferred method of removing PM from diesel exhaust flow, for some engine duty cycles the exhaust temperature is consistently too cold for regeneration. An active DPF system is used in applications where it is difficult to maintain the needed high exhaust temperatures required for a passive DPF system. Regeneration occurs in an active system when the exhaust temperature is increased by adding heat from an external source to the exhaust flow. External heat sources may be injected fuel and electric heating devices including resistance and microwave radiation. Active regeneration is not a continuous process, but occurs when the exhaust back pressure reaches a preset pressure triggering the injection of external energy to heat the exhaust to the ignition temperatures of the soot deposits. The two primary concerns associated with active regeneration are the consumption of additional energy or fuel and the thermal gradients created across the filter, due to the soot's rapid combustion. The challenge for both resistive and microwave regeneration is it may require more electrical energy from the vehicle than is available from the vehicle's alternator/battery system.

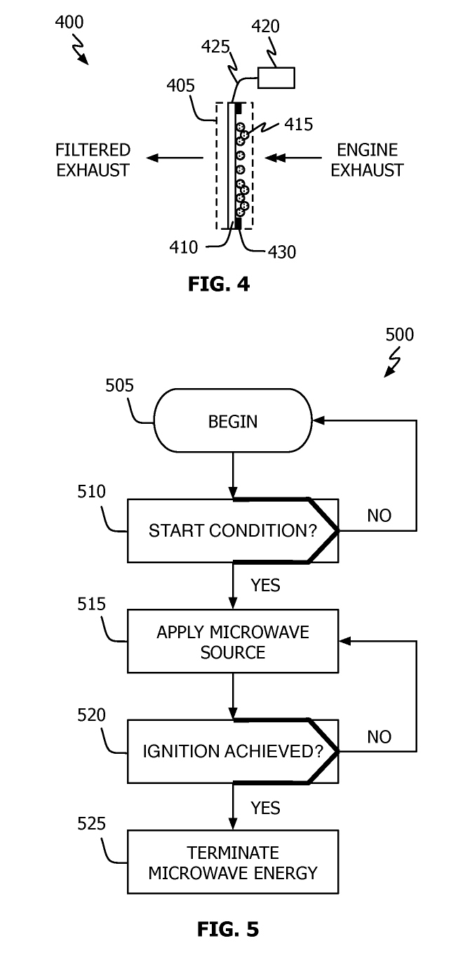

Referring to FIG. 4, an active DPF in accordance with one embodiment of the invention is shown in schematic form. As shown, DPF 400 includes housing 405 that encloses ceramic filter plate(s) 410. Engine exhaust is passed to a first side of ceramic filter 410 (in a region created by housing 405) wherein particulate matter 415 builds up. When sufficient particulate matter 415 accumulates to cause a threshold back pressure (detected by, for example, a pressure sensor—not shown), microwave energy source 420 is activated so that microwave energy is supplied via microwave guide or channel 425 to ceramic filter 410. Ceramic filter 410, in turn, is loaded with a specified amount of carbon nanotube material (e.g., 1.5 wt-%). In practice, microwave energy supplied by source 420 (e.g., a magnetron) is kept from “leaking” away from ceramic filter 410 by Faraday cage 430. It will be appreciated that the phrase “Faraday cage” refers to any electromagnetically conductive shell, mesh or covering that is intended to prevent microwave energy from leaking away from its intended target—in this example, ceramic filter 410.

Referring to FIG. 5, method 500 to use filter 400 in accordance with one embodiment of the invention is illustrated. During operation, a start condition is monitored 505. One illustrative start condition is back pressure presented to the engine as a result of soot build-up. Another start condition is time. For example, a regeneration cycle may be initiated ever specified number of hours of engine operation. The starting condition can be a factor of many conditions such as, for example, the engine type, fuel type, type of driving and the environment within which the driving occurs. Accordingly, the chosen “starting condition” is a matter of choice for the vehicle designer. After each check, if the regeneration start condition is not met (the “NO” prong of block 510), operations resume at block 505 until the specified start condition is met.

If, on the other hand the regeneration start condition is met (the “YES” prong of block 510), microwave source 420 may be activated to supply microwave energy to the ceramic filter having embedded nanotube material (block 515). Once microwave source 420 has been activated, a check is made to determine if sufficient energy has been supplied to ignite the built-up soot. If the soot has not been ignited (the “NO” prong of block 520), microwave energy continues to be supplied (block 515). If the soot has been ignited (the “YES” prong of block 520), microwave source 420 is deactivated (block 525). In another embodiment, temperature and pressure may be monitored in the region created by housing 405 on that side of ceramic filter 410 exposed to engine exhaust and microwave energy source regulated (i.e., controlled) so as to ensure that the built-up soot is ignited and combusted and that the temperatures and pressures generated during the regeneration process do not damage the filter 400. For example, as the monitored temperature and/or pressure increase to a specified limit the amount of microwave energy supplied by microwave source 420 may be reduced. At this point, soot combustion continues until complete at which point the process self-terminates. It will be appreciated that an actual implementation of regeneration process 500 may have additional, or fewer, steps. For example, there may be a limit on the time microwave energy is supplied to prevent damage to filter 400. In addition, microwave detectors may be placed external to Faraday cage 430 and configured to deactivate source 420 should more than a specified amount of microwave energy be detected.

Contrary to published research, this disclosure shows that ceramic materials (e.g., silicon carbide and cordierite) may be used in high-temperature applications such as microwave regenerated DPF systems. Specifically, results presented in this disclosure indicate cordierite substrates embedded with carbon nanotubes are capable of reaching the burn-off temperature of soot with a relatively low microwave power input (see FIG. 3). The benefits of this are at least two-fold. First, the power required to reach the temperature needed for regeneration is well within the power budget of most vehicles. As a result of needing less power, a filter may be regenerated more frequently during cold duty cycles when the soot production is at its peak. Regeneration with a low soot load substantially eliminates the high temperatures created in the filters as the soot burns off, thereby eliminating the need for the higher melting temperature rating of silicon carbide. Second, and contrary to established practice, results reported herein indicate that cordierite may be used as the heating mechanism. This is significant not only because cordierite is less expensive than silicon carbide, but also has a thermal expansion coefficient better suited for this application. In summary, this disclosure provides at least the following advantages when applied to a microwave regenerated DPF system: (1) reduced electrical load on a vehicle's alternator/battery system; (2) reduced engine back pressure due to more frequent regeneration; (3) faster regeneration without damage to filter media; (4) reduced size and weight of the filter system; and (5) reduced cost of the ceramic filter medium.

Another specific application in accordance with the invention implements a device and system to maintain the thermal quality of personnel while maintaining the air temperature of a commercial building at a temperature typically considered too cold. In this embodiment, an individual's comfort may be controlled by a system of low wattage, fast response infrared heaters (ceramic substrates having carbon nanotube material embedded therein). These heaters could be activated based on an individual's desired level as determined by a network of wireless devices associated with each individual and coupled to an intelligent heating and cooling control system.

A typical commercial heating ventilation and air conditioning (HVAC) system contains an energy management system, a Freon® type air conditioning system and gas fired heater often located on the roof or on the ground near the building, a large air handling unit (AHU) that moves the building air through the condensing coils of the air conditioner or heater, and a system of air distribution boxes that control air flow from the air handler into the individual zones. (FREON is a registered trademark of E. I. Du Pont de Nemours And Company.) Such systems are typically controlled by energy management system software operating from a computer collecting temperature information from a network of sensors separated into zones. During summer months, conditioned air flows into the zones through air distribution boxes. Cooled and dehumidified air feeding into the air distribution boxes originates from air conditioner condensing coils. For most people this air, nearly 15° C., is too cold for prolonged exposure. Therefore air distribution boxes are designed to control the room air temperature by regulating the volume of cold air discharged into the room. Depending on system design, air distribution boxes may contain a hot water heat exchanger or electrical heating elements to increase the temperature of the air flowing into the zones. In the warmer climate zones they are also used to heat the building during the winter months. Depending on the climate zone the air conditioner may also be used during the winter months to control humidity in the building and to supply outside air to the air distribution boxes.

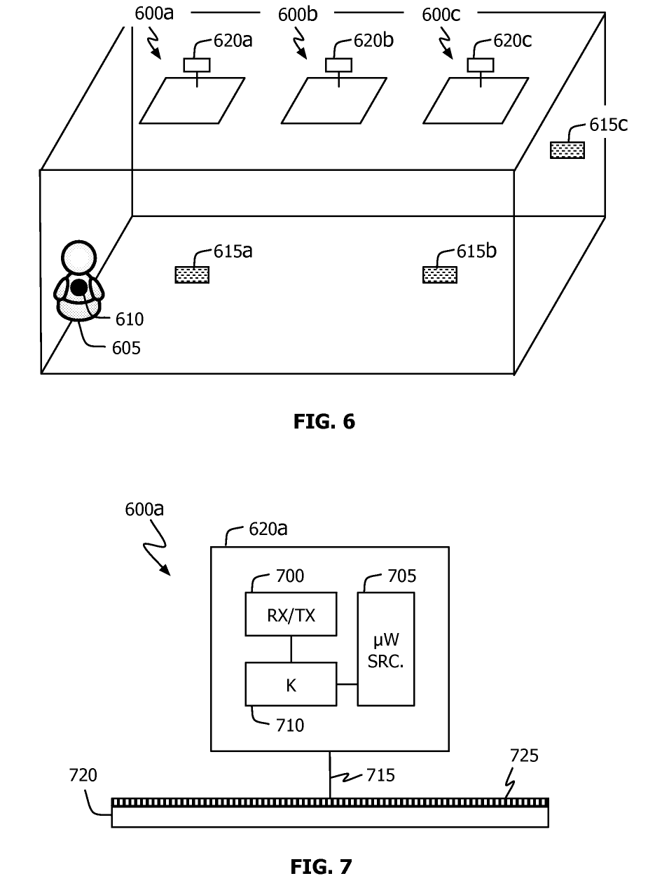

Referring to FIG. 6, in this application it is envisioned a number of fast responding infrared heaters 600 (e.g., 600a, 600b and 600c) in accordance with the invention will be installed into the ceiling grid system, walls and, possibly, other surfaces. Heater units 600 will normally be off. As individual 605 enters an area, that person's radio frequency identification (RFID) badge 610 is detected by a plurality of detectors 615 (e.g., 615a, 615b and 615c) which are communicatively coupled to heater control units 620 (e.g., 620a, 620b and 620c) and/or one or more heating ventilation and air conditioning (HVAC) control computers (not shown). The individual's RFID will identify the person approaching and, via control software, activate each heater unit as the individual occupies the space within the radiation range of the heater unit. Once the employee exists the space, the RFID relevant heater unit will be deactivated. It will be recognized that other means of determining when an individual enters and exits a space, other than RFID technology, are known and are equally applicable to the described application.

In the illustrative embodiment, each individual's RFID may have programmed within it that individual's desired temperature or temperature range, both of which may be allowed to change based on the season and ambient temperature. Thus, as an individual moves into an area, that person's RFID temperature setting is detected and communicated to heater control units 620 (e.g., directly from detector units 615 or indirectly from HVAC control computers).

It is envisioned that different manufacturers of ceramic heater units will employ different loads of carbon nanotube material and different levels of microwave power sources which, when located in surfaces of varying shapes and distances from users (i.e., individuals 605) will require different power profiles to achieve the desired heating results. For example, a single one-foot square heating unit in a ceiling grid three feet above the head of an average individual being driven by a 500 watt microwave energy source will have one warm-up profile (e.g., see FIGS. 1 and 2) to reach a target heat range (e.g., 26° C.) within a specified time, while the same heater until being driven by a 750 watt microwave energy source will have a different profile. Thus, the time needed by each heater unit to generate the desired heat energy will be dependent upon many factors (e.g., location of ceramic substrate, shape and size of ceramic substrate, loading of carbon nanotube material in the ceramic substrate material, the type of ceramic substrate, the distance of the ceramic substrate from the intended user and the amount of microwave power being applied to the carbon nanotube-ceramic heater panel), but will nonetheless be within the ability of one of ordinary skill having the benefit of this disclosure. These same considerations must be taken into account when more than one person is in an area at once. One prime example of this is in a conference room. In these situations, the manufacturer of the HVAC control system may determine the approach. For example, when multiple individuals are detected in a common area, all heating units in the area may be activated to heat to the average of the assembled individuals desired temperatures. Alternatively, the target temperature may be set to the median temperature of the detected individuals or to 75% of the highest desired temperature. The possibilities are virtually endless. One simply needs to select an approach and program their HVAC control system to accommodate it.

Referring to FIG. 7, heater unit 600a is shown in block diagram form. As illustrated, control unit 620a comprises receiver/transmitter 600, microwave source 605 (e.g., a magnetron) and controller 610. In one embodiment, controller 610 comprises a digital controller or microprocessor and RX/TX 600 includes the necessary analog-to-digital and digital-to-analog circuitry needed to interface the digital circuitry of controller 610 with the radio frequency circuitry of RX/TX 600. Whether dedicated or special purpose hardware or a general purpose computer processor under control of special purpose programming, controller 610 issues signals to microwave energy source 605 which supplies energy via microwave horn or channel 615 to nanotube material impregnated ceramic substrate 620. While microwave channel 615 is substantially identical in function to microwave guide 425 (see FIG. 4), other methods of transferring microwave energy from source 605 to substrate 620 may be used, including for example, a microwave horn or patterning a microwave antennae directly on the surface of the ceramic substrate 620 (i.e., on the surface being exposed to microwave energy) using conventional metal deposition and pattern technologies commonly used in microelectronic fabrication. In general, the objective is to minimize as much as possible the size of the microwave applicator and power required while maintaining as high as possible the efficiency of the system. As discussed above with respect to the diesel particulate filter embodiment, ceramic substrate 620 may utilize electromagnetic shield (e.g., a Faraday cage) 625 to contain microwave energy to the top surface of ceramic substrate 620 (for personnel safety).

For illustrative purposes, control unit 620 has been described as including radio frequency RX/TX unit 600. One of ordinary skill in the art will recognize that the same functionality may be achieved using wired communications. In the case of digital communications, it will be further understood that controller 610 may receive digital signals directly without the need for analog conversion.

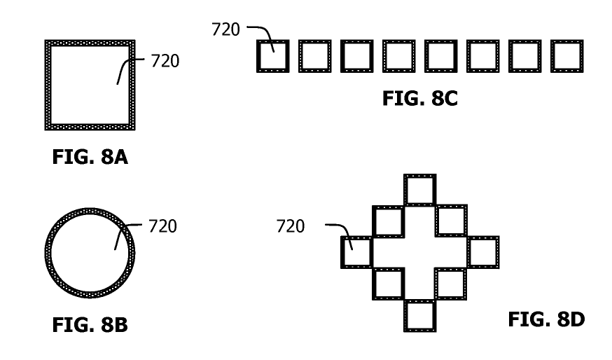

Referring to FIG. 8, ceramic substrates 620 may be formed into virtually any shape so as to fit into any surface. For example, each heater until may utilize a single substrate such as shown FIGS. 8A and 8B. Alternatively, multiple substrates may be combined (supplied by a single microwave energy source) to form arbitrary shapes such as a rectangle (FIG. 8C) or a diamond (FIG. 8D). As shown in FIGS. 8A-8D, each substrate having carbon nanotube material may include a region (shown as a dark area) that does not include carbon nanotube material. This region or buffer zone would not be heated by microwave energy and would, therefore, not get actively heated. (It would still get heated through conduction from those regions that are heated by microwave energy.) To excessive heat build-up at the edges of each substrate, these regions could also be constructed of a heat insulating material. The purpose of including these regions is to minimize the conductive transfer of significant heat to the substrates' surrounding.

Various changes in the materials, components, circuit elements, as well as in the details of the illustrated operational methods are possible without departing from the scope of the following claims. For instance, the illustrative devices of FIGS. 4, 7 and 8 may use ceramic materials other than silicon carbide and cordierite. In addition, acts in accordance with FIG. 5 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

1. A heating device, comprising:
a ceramic substrate having carbon nanotube material embedded therein and further having a first surface and a second surface;
a microwave energy source configured to supply microwave energy to the first surface; and
an inlet means for admitting material to an a region proximate the second surface,
wherein at least some of the supplied microwave energy is configured to heat the material that is in contact with the second surface.

2. The heating device of claim 1, wherein the material comprises a solid.

3. The heating device of claim 2, wherein the solid material comprises particulate matter.

4. The heating device of claim 1, wherein the material comprises fluid.

5. The heating device of claim 4, wherein the fluid comprises a liquid.

6. The heating device of claim 5, wherein the liquid comprises water.

7. The heating device of claim 1, wherein the ceramic filter comprises between approximately 0.5 and 1.5 wt-% carbon nanotube material.

8. An active regenerative filter device, comprising:
a ceramic filter having carbon nanotube material embedded therein and further having a first surface, the first surface configured to be exposed to a gas having particulate matter therein; and
a microwave energy source configured to selectively supply microwave energy to the first surface,
wherein the selectively supplied microwave energy heats the ceramic filter to combust the particulate matter.

9. The active regenerative filter device of claim 8, wherein the ceramic filter comprises silicon carbide.

10. The active regenerative filter device of claim 8, wherein the ceramic filter comprises cordierite.

11. The active regenerative filter device of claim 8, wherein the ceramic filter comprises between approximately 0.5 and 1.5 wt-% carbon nanotube material.

12. The active regenerative filter device of claim 8, further comprising an electromagnetic shield configured to substantially limit microwave energy supplied to the first surface from escaping from the filter device.

13. A diesel particulate filter (DPF) disposed downstream of an engine, the DPF comprising:
a ceramic filter substrate having embedded therein carbon nanotube material and a first surface, the first surface configured to be exposed to exhaust from the engine, the exhaust including particulate matter;
a microwave energy source configured to supply microwave energy to the first surface; and
an electromagnetic shield configured to substantially enclose the first surface, wherein microwave energy from the microwave energy source selectively heats the embedded carbon nanotube material to ignite at least some of the particulate matter collected on the first surface.

14. The diesel particulate filter (DPF) of claim 13, wherein the ceramic filter substrate comprises silicon carbide.

15. The diesel particulate filter (DPF) of claim 13, wherein the ceramic filter substrate comprises cordierite.

16. The diesel particulate filter (DPF) of claim 13, wherein the ceramic filter substrate comprises between approximately 0.5 and 1.5 wt-% carbon nanotube material.

17. An active regeneration filter method, comprising:
determining when to start a regeneration operation for a filter having a ceramic substrate with carbon nanotube material embedded therein;
supplying microwave energy to a surface of the ceramic substrate filter having particulate matter collected thereon; and
halting the supply of microwave energy to the surface of the ceramic substrate when ignition of the particulate matter is detected.

18. The method of claim 17, wherein the particulate matter comprises diesel particulate matter and the act of determining when to start a regeneration operation comprises detecting an engine backpressure equal to or greater than a specified threshold backpressure.

19. The method of claim 17, wherein the particulate matter comprises diesel particulate matter and the act of determining when to start a regeneration operation comprises determining a specified elapsed time from a prior regeneration operation.

20. A program storage device, readable by a programmable control device, comprising instructions stored on the program storage device for causing the programmable control device to perform the method of claim 17.

21. A heater device, comprising:
a ceramic substrate having carbon nanotube material embedded therein and further having a first surface and a second surface;
a microwave energy source configured to supply microwave energy to the first surface; and
a control unit configured to selectively activate the microwave energy source,
wherein at least some of the supplied microwave energy is configured to radiate away from the second surface.

22. The heating device of claim 21, wherein the ceramic filter comprises between approximately 0.5 and 1.5 wt-% carbon nanotube material.

23. A infrared space heater device, comprising:
a ceramic substrate having carbon nanotube material embedded therein and further having a first surface;
a energy source configured to supply microwave energy to the first surface of the ceramic substrate; and
a control unit configured to selectively activate the energy source.

24. The infrared space heater device of claim 23, wherein the ceramic substrate comprises silicon carbide.

25. The infrared space heater device of claim 23, wherein the ceramic substrate comprises cordierite.

26. The infrared space heater device of claim 23, further comprising an electromagnetic shield substantially enveloping the first surface.

27. The infrared space heater device of claim 23, wherein the ceramic substrate comprises between approximately 0.5 and 1.5 wt-% carbon nanotube material.

28. The infrared space heater device of claim 23, wherein the ceramic substrate is configured to fit into a ceiling grid of a commercial building.

29. The infrared space heater device of claim 23, further comprising a wireless receiver-transmitter unit communicatively coupled to the control unit.
